(19) United States
(12) Patent Application Publication
(10) Pub. No.: US 2016/0189143 A1
(43) Pub. Date: Jun. 30, 2016

(54) SYSTEM, METHOD, AND APPARATUS FOR LOCATING A BLUETOOTH ENABLED TRANSACTION CARD

(71) Applicant: Capital One Services, LLC, McLean, VA (US)

(72) Inventor: Adam R. KOEPPEL, Washington, DC (US)

(21) Appl. No.: 14/977,730

(22) Filed: Dec. 22, 2015

Related U.S. Application Data
(60) Provisional application No. 62/095,190, filed on Dec. 22, 2014.

(51) Int. Cl. G06Q 20/34; G06Q 20/32; G06K 19/073

(52) U.S. Cl. CPC G06Q 20/354; G06K 19/0739; G06Q 20/327; G06Q 20/3224; G06Q 20/325

(57) ABSTRACT

A system for transmitting and receiving proximity data associated with a transaction card may include a Bluetooth-enabled microchip transaction card, an account provider system, and a mobile device. When a user device and a card are paired, the user device may receive a notification when the card is outside of a specified distance from the user device. A user device may be connected to a Bluetooth mesh network, connecting the user device to a number of Bluetooth enabled devices such that when the transaction card is outside of a specified distance of the mesh network, the user device may receive an alert. When a user receives an alert that the card is outside of a specified distance from the user device, the user device may be used to relay to the user whether the user is moving in a direction closer or farther from the card.

### CROSS-REFERENCE TO RELATED APPLICATIONS

This application contains subject matter related to and claims the benefit of U.S. Provisional Patent Application No. 62/095,190, filed on Dec. 22, 2014, the entire contents of which is incorporated herein by reference.

### FIELD OF THE DISCLOSURE

The present disclosure relates to a systems, methods, and apparatus for using a bluetooth connection status to locate and control aspects of a Bluetooth-enabled card, such as a transaction card and the like.

### BACKGROUND OF THE DISCLOSURE

Misplacing or losing a card, such as a transaction card or a fare cant results in the requirement of a new card. Additionally, when a card has been misplaced or lost, the account associated with the card is subject to being fraudulently used by individuals other than the card holder.

Moreover, searching for a transaction card when it has been misplaced can be an arduous task. These and other drawbacks exist.

### SUMMARY OF THE DISCLOSURE

Various embodiments of the present disclosure provide systems, methods, and apparatus for locating a Bluetooth-enabled card, such as a transaction card and the like. In an exemplary embodiment, a system for locating a Bluetooth-enabled card may include a transaction card including Bluetooth input/output, such as a Bluetooth module or chipset, an account provider system, and a mobile device, such as a smartphone, tablet, phablet, laptop, or the like. A card may include an embedded microprocessor chip, or integrated circuit (IC), housing various modules to provide card capabilities, such as transaction capabilities, security capabilities, and location capabilities. An account provider system may include a number of servers and computers, each equipped with storage and modules programmed with various capabilities, such as, storing cardholder data, transaction processing, and/or transaction card location tracking data, such as data that provides a proximity of the card to a user device. A user device may include various hardware and software components, such as a Near Field Communication (NFC) hardware and software components, Bluetooth input/output hardware and software, and one or more processors, various input/output interfaces, and/or modules, such as transaction processing modules and transaction card resetting modules. Each component of the system may communicate with each other in order to locate the card and/or determine that the card is proximate to another device. A card, as discussed herein, may include a transaction card, such as a debit card, a credit card, a pre-paid card, and the like; a fare card, such as a subway or metro card; a membership card; a loyalty card; and/or any other type of physical card held by an account holder.

A card may be located for various security reasons. For example, a card holder may use a transaction card at a store and leave the transaction card behind or a fare card may be used and accidentally dropped. An account holder may also possess a Bluetooth-enabled device, such as a smartphone, tablet, or the like. When the user's Bluetooth-enabled device and the Bluetooth-enabled card are linked, the card may be located using a user device. A Bluetooth-enabled device may include the capabilities to establish a link between a card and the device using device settings (e.g., iOS or Android settings that manage Bluetooth connections) and/or mobile application(s) associated with the card issuer that can cooperate with the device controls to manage a Bluetooth connection with the card. As used herein, locating a card may include determining that the card is within/or outside of a certain distance and/or determining whether a user device is moving in a direction near the card.

For example, when a user device and a card are paired, the user device may receive a notification when the card is outside of a specified distance from the user device. Also, a user device may be connected to a Bluetooth mesh network, connecting the user device to a number of Bluetooth enabled devices such that when the transaction card is outside of a specified distance of the mesh network, the user device may receive an alert. Further, when a user receives an alert that the card is outside of a specified distance from the user device, the user device may be used to relay to the user whether the user is moving in a direction closer or farther from the card.

If a user is unable to locate the card, such as if a card were stolen or simply unlocateable, the user may be able to instruct an account provider to disable the card. Moreover, the card may include a dynamic display, such that when it is outside a predetermined range, the card displays a “lost mode” message, such as “Lost Card. Please Contact (555) 555-1234.

Bluetooth technologies include various hardware and software components that use Bluetooth, or a wireless technology standard for exchanging data over short distances. Bluetooth technology may include technology to transmit data using packets, such that each packed is transmitted over a Bluetooth channel. For example, a Bluetooth channel may have a bandwidth of 1 MHz or 2 MHz with the number of channels being 79 or 40, respectively. Hardware that may be included in Bluetooth technology includes a Bluetooth module or chipset with a Bluetooth transceiver, a chip, and an antenna. The transceiver may transmit and receive information via the antenna and an interface. The chip may include a microprocessor that stores and processes information specific to a piconet and provides device control functionality. Device control functionality may include connection creation, frequency-hopping sequence selection and timing, power control, security control, polling, packet processing, and the like. Accordingly, a card holder may locate a card when the card and a user device are paired and part of a piconet.

For additional security, an application may be added to a user device in order to access card location functionality. For example, a location service may be included and require user authentication before a card is paired to the user device and/or proximity data is received and/or transmitted. User authentication may include, for example, a password, PIN, and/or biometric data (fingerprint, facial recognition, and the like).

According to an example embodiment, a user device may include an input/output interface having an antenna component that is paired to a Bluetooth-enabled transaction card and receives proximity data from the transaction card via Bluetooth network, and a processor that generates a notification to alert a user that the proximity data received from the transaction card indicates that the transaction card is greater than a specified distance from the user device, wherein input/output interface receives a response from the user based on the notification, wherein the processor performs at least one of the following based on the response: generates deactivation data associated with the transaction card and transmits the deactivation data using the input/output interface to an account provider system; generates an override alert associated with the transaction card and transmits the override alert using the input/output interface to an account provider system; generates a report including the proximity data received from the transaction card and GPS data received via a GPS component on the user device; and generates user-specified transaction card display data and transmits the transaction card display data using the input/output interface to the transaction card to display on a dynamic display. An account provider system may manage the account associated with the transaction card and participate in transaction authorization associated with the transaction card.

Proximity data may include Bluetooth low energy (BLE) data received via a Bluetooth network. Proximity data may include, for example, the existence of a connection, signal strength associated with a connection, response time data, and/or a combination of any of the above. The specified distance may be user-specified, wherein a user specified the distance using a user device input/output interface, such as a touchscreen or a keyboard. The specified distance may be account provider-specified and may be determined by and/or received from an account provider system. The specified distance may be specified by a Bluetooth or BLE standard.

A notification may be received and/or generated. A notification may be received via a network and may include, for example, a push notification, a text message, a voice message, and/or a vibration notification. The user device may also include a receiver to receive data, such as location data, that may be used to generate location-based data. Location data and/or location-based data may include, for example, global positioning system (GPS) data, radio signal data, electro-magnetic data, IP address data, and/or any combination of the above.

Deactivation data may include, for example, a transaction card number, deactivation time, deactivation date, account holder name, location data associated with the user device, and/or any combination of the above. An override alert may include, for example, a transaction card number, time, date, account holder name, location data associated with the user device, and/or any combination of the above.

The user device may also include a display to display a generated report in a map format mapping GPS data associated with the user device. A transaction card may also include a display to display, for example, an account holder name, an account holder contact phone number, a deactivation message, and/or any combination of the above.

In an example embodiment, a transaction card may include a Bluetooth-enabled transaction card having a microprocessor chip storing transaction card data and an antenna connected to the microprocessor chip, where the antenna: receives a pairing attempt from a user device over a Bluetooth network; establishes a Bluetooth connection with the user device; receives a request for proximity data from the user device; transmits the proximity data to the user device in response to the request; and receives an deactivation response from the user device indicating that the transaction card is deactivated. The transaction card may use, for example. Bluetooth low energy (BLE).

Proximity data may include, for example, an existence of a connection, signal strength associated with the connection, response time data, and/or any combination of the above. Transaction card data may include, for example, an account holder name, an account holder identifier, an account number, an account balance, a transaction history, an account holder contact telephone number, and/or any combination of the above. A request for location data may be received from the user device at predefined intervals. Proximity data may be transmitted from the transaction card a predefined intervals. Proximity data may be transmitted only upon receipt of the request for proximity data from the user device.

A transaction card may also comprise a display to display deactivation data. Deactivation data may include, for example, an account holder name, an account holder contact phone number, a deactivation message, and/or any of the above.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for locating a Bluetooth-enabled card according to embodiments of the disclosure;

FIG. 2 depicts an example embodiment of a system for locating a Bluetooth-enabled card according to embodiments of the disclosure;

FIG. 3 depicts an example method for locating a Bluetooth-enabled card according to embodiments of the disclosure;

FIG. 4 depicts an example card-device linking system according to embodiments of the disclosure

FIG. 5 depicts an example embodiment of a system and method for initiating a connection between a device and card and the respective link layers;

FIG. 6 depicts an example embodiment of a system and method for initiating a connection between a device and card and the respective link layers; and

FIG. 7 depicts an example embodiment of a system and method for sending data between a device and card and the respective link layers.

### DETAILED DESCRIPTION OF THE EMBODIMENTS

The following description is intended to convey a thorough understanding of the embodiments described by providing a number of specific example embodiments and details involving systems, methods, and devices for locating a Bluetooth-enabled transaction card. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only. For example, many other account providers may exist, such as retail stores, loyalty programs, membership programs, transportation providers (e.g., a fare card), a housing provider, and the like.

Additionally, a transaction card is used as an example of a Bluetooth-enabled card. A transaction card may include any type of Bluetooth-enabled card used in any type of transaction, including, for example, debit cards, credit cards, pre-paid cards, cards used in transportation systems, membership programs, loyalty programs, hotel systems, and the like. The use of “mobile device” in the examples throughout this application is only by way of example, and locating a Bluetooth-enabled card may also be used with personal computers, tablet, gaming system, television, or any other device capable of locating a Bluetooth-enabled transaction card.

According to the various embodiments of the present disclosure, systems, methods, and devices are provided to locate a Bluetooth-enabled transaction card. Such embodiments may provide, for example, notifications and alerts to a user device when a transaction card is outside of a specified distance from the transaction card. Notifications and alerts may be provided in the form of a push notification, a text, a voice message, and/or application notification such as those associated with mobile banking applications. In various embodiments, locating a transaction card could be provided with the assistance of a network environment, such as a Bluetooth network and/or a Bluetooth mesh network environment.

In various embodiments, locating a transaction card and/or determining the proximity of the transaction card to a paired device could be provided with the assistance of a networked environment, such as a cellular or Internet network, whereby, for example, a mobile device such as a smartphone could transmit indication of a lost or stolen card based on a received notification of a card being outside a specified range to an account provider via a communication network.

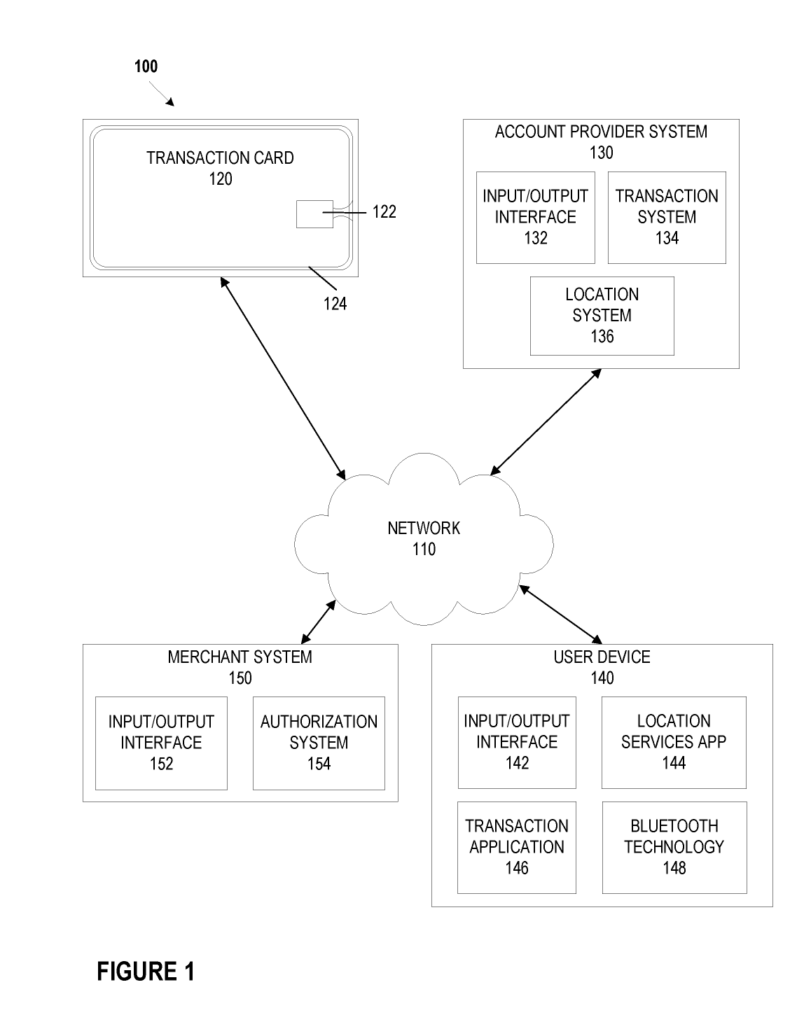

FIG. 1 depicts an example system 100 for use with the system and devices for locating a Bluetooth-enabled transaction card. As shown in FIG. 1, an example system 100 may include one or more Bluetooth-enabled transaction cards 120, one or more account provider systems 130, one or more user devices 140, and one or more merchant systems 150 connected over one or more networks 110.

For example, network 110 may be one or more of a wireless network, a wired network or any combination of wireless network and wired network. For example, network 110 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, a Bluetooth network, or any other wired or wireless network for transmitting and receiving a data signal.

In addition, network 110 may include, without limitation, telephone lines, fiber optics, IEEE Ethernet 902.3, a wide area network (“WAN”), a local area network (“LAN”), a wireless personal area network (“WPAN”), or a global network such as the Internet. Also network 110 may support an Internet network, a wireless communication network, a cellular network, or the like, or any combination thereof. Network 110 may further include one network, or any number of the example types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

Account provider system 130, user device 140, and/or merchant system 150 may include, for example, one or more mobile devices, such as, for example, personal digital assistants (PDA), tablet computers and/or electronic readers (e.g., iPad, Kindle Fire, Playbook, Touchpad, etc.), wearable devices (e.g., Google Glass), telephony devices, smartphones, cameras, music playing devices (e.g., iPod, etc.), televisions, set-top-box devices, and the like.

Account provider system 130, user device 140, and/or merchant system 150 also may include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network.

Account provider system 130, user device 140, and/or merchant system 150 may include at least one central processing unit (CPU), which may be configured to execute computer program instructions to perform various processes and methods. Account provider system 130, user device 140, and/or merchant system 150 may include data storage, including for example, random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

Account provider system 130, user device 140, and/or merchant system 150 may further include, for example, a processor, which may be several processors, a single processor, or a single device having multiple processors. Although depicted as single elements, it should be appreciated that according to one or more embodiments, account provider system 130, user device 140, and/or merchant system 150 may comprise a plurality of account provider systems 130, user devices 140, and/or merchant systems 150.

Account provider system 130, user device 140, and/or merchant system 150 may further include data storage. The data storage may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

As shown in FIG. 1, each account provider system 130, user device 140, and/or merchant system 150 may include various components. As used herein, the term “component” may be understood to refer to computer executable software, firmware, hardware, and/or various combinations thereof. It is noted there where a component is a software and/or firmware component, the component is configured to affect the hardware elements of an associated system. It is further noted that the components shown and described herein are intended as examples. The components may be combined, integrated, separated, or duplicated to support various applications. Also, a function described herein as being performed at a particular component may be performed at one or more other components and by one or more other devices instead of or in addition to the function performed at the particular component. Further, the components may be implemented across multiple devices or other components local or remote to one another. Additionally, the components may be moved from one device and added to another device, or may be included in both devices.

As depicted in FIG. 1, system 100 may include a transaction card 120. A transaction card may include any transaction card that is Bluetooth enabled using a microprocessor chip 122 and an antenna 124. A Bluetooth-enabled transaction card may support Bluetooth Low Energy (BLE). A transaction card may include an Europay MasterCard Visa (EMV) card, a “Chip and PIN” card, and/or a contactless smart card. A microprocessor chip 122 embedded in the transaction card 120 may include a number of contacts that may be connected and activated using an interface device, such as a user device 140. Once paired via Bluetooth network, the transaction card 120 may be in communication with a third party device, such as, for example, the user device 140. Pairing and communications may be established between the transaction card 120 and other interfacing devices, such as a terminal (not shown), a merchant system 150, and the like. A Bluetooth-enabled device may include the capabilities to establish a link between a card and the device (or pair the devices) using device settings (e.g., iOS or Android settings that manage Bluetooth connections) and/or mobile application(s) associated with the card issuer that can cooperate with the device controls to manage a Bluetooth connection with the card. After pairing has been established, the location of the transaction card 120 may be determined using the user device 140. Location of the transaction card 120 may be based on data received from the transaction card 120 such as, for example, proximity data (e.g., existence of a connection, signal strength associated with the connection, response time data, and the like). For example, where a user device 140 and the transaction card 120 are greater than a specified distance apart from each other, the user device 140 may no longer receive connection data associate with the transaction card 120, may receive poor signal strength data associated with the transaction card 120, may receive a specific response time associated with a ping to the transaction card 120, and, in response may receive and/or generate a notification. The notification may be in the form of, for example, a push notification, a text message, a voice message, and the like. In this manner, the transaction card 120 acts as a beacon using a Bluetooth connection to tell the user device 140 a proximate location of the transaction card 120 to the user device 140.

Account provider system 130 may include systems associated with, for example, a banking service company such as Capital One®, Bank of America®, Citibank®, Wells Fargo®, Sun Trust, various community banks, and the like, as well as a number of other financial institutions such as Visa®, MasterCard®, and AmericanExpress® that issue credit and/or debit cards, for example, as transaction cards. Account provider system 130 may include and/or be connected to one or more computer systems and networks to process transactions. Account provider system 130 may include systems associated with financial institutions that issue transaction cards, such as a transaction card 120, and maintains a contract with cardholders for repayment. In various embodiments, an account provider system 130 may issue credit, debit, and/or stored value cards, for example. Account provider system 130 may include, by way of example and not limitation, depository institutions (e.g., banks, credit unions, building societies, trust companies, mortgage loan companies, pre-paid gift cards or credit cards, etc.), contractual institutions (e.g., insurance companies, pension funds, mutual funds, etc.), investment institutions (e.g., investment banks, underwriters, brokerage funds, etc.), and other non-bank financial institutions (e.g., pawn shops or brokers, cashier's check issuers, insurance firms, check-cashing locations, payday lending, currency exchanges, microloan organizations, crowd-funding or crowd-sourcing entities, third-party payment processors, etc.).

Account provider system 130 may include an input/output interface 132, a transaction system 134, and a location system 136. Input/output interface 132 may include for example, I/O devices, which may be configured to provide input and/or output to providing party system 130 (e.g., keyboard, mouse, display, speakers, printers, modems, network cards, etc.). Input/output interface 132 also may include antennas, network interfaces that may provide or enable wireless and/or wire line digital and/or analog interface to one or more networks, such as network 110, over one or more network connections, a power source that provides an appropriate alternating current (AC) or direct current (DC) to power one or more components of providing party system 130, and a bus that allows communication among the various components of providing party system 130. Input/output interface 132 may include a display, which may include for example output devices, such as a printer, display screen (e.g., monitor, television, and the like), speakers, projector, and the like. Although not shown, each providing party system 130 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, and the like.

Transaction system 134 may include various hardware and software components to communicate between a merchant, acquisition system, account provider system, and/or a user device to process a transaction, such as a user purchase. Location system 136 may include various hardware and software components, such as data storage (not shown) to store location data associated with a transaction card (e.g., time and date of pairing, time and date of transaction card/user device being a specified distance apart, GPS data associated with the user device, proximity data, and the like) and cardholder data (e.g., cardholder name, address, phone number(s), email address, demographic data, and the like). Location system 136 also may include hardware and software components to generate transaction card reports in order to report location data associated with a user device 140 and proximate data associated with a transaction card 120. For example, a processor may generate a report when the account provider system receives a notification that a user device 140 and transaction card 120 are greater than a specified distance apart. The report may include a time and date associated with the notification and/or GPS data associated with the user device 140 (e.g., address data, map display, longitude/latitude components, and the like).

A user device 140 may be any device capable communicating using Bluetooth technology with a transaction card 120 and execute various function to transmit and receive proximity data (e.g., a proximity of the transaction card 120 to the user device 140) associated with the transaction card 120. Proximity data may include, for example, an existence of a connection, signal strength associated with the connection, response time data, and the like.

For example, user device 140 could be an iPhone, iPod, iPad from Apple® or any other mobile device running Apple's iOS operating system, any device running Google's Android® operating system, including, for example, smartphones running the Android® operating system and other wearable mobile devices, such as Google Glass or Samsung Galaxy Gear Smartwatch, any device running Microsoft's Windows® Mobile operating system, and/or any other smartphone or like device.

User device 140 may include for example, an input/output interface 142, a location services application 144, and a transaction application 146. Input/output interface 142 may include a Bluetooth module or chipset with a Bluetooth transceiver, a chip, and an antenna. The transceiver may transmit and receive information via the antenna and an interface. The chip may include a microprocessor that stores and processes information specific to a piconet and provides device control functionality. Device control functionality may include connection creation, frequency-hopping sequence selection and timing, power control, security control, polling, packet processing, and the like. The device control functionality and other Bluetooth-related functionality may be supported using a Bluetooth API provided by the platform associated with the user device 140 (e.g., The Android platform, the iOS platform). Using a Bluetooth API, an application stored on a user device 140 (e.g., a banking application, a card location application, etc.) or the device may be able to scan for other Bluetooth devices (e.g., a Bluetooth-enabled transaction card 120), query the local Bluetooth adapter for paired Bluetooth devices, establish RFCOMM channels, connect to other devices through service discovery, transfer data to and from other devices or a transaction card 120, and manage multiple connections. A Bluetooth API used in the methods, systems, and devices described herein may include an API for Bluetooth Low Energy (BLE) to provide significantly lower power consumption and allow a user device 140 to communicate with BLE devices that have low power requirements, such as transaction card 120.

Input/output interface 142 may include for example, I/O devices, which may be configured to provide input and/or output to user device 140 (e.g., keyboard, mouse, display, speakers, printers, modems, network cards, etc.). Input/output interface 142 also may include antennas, network interfaces that may provide or enable wireless and/or wire line digital and/or analog interface to one or more networks, such as network 110, over one or more network connections, a power source that provides an appropriate alternating current (AC) or direct current (DC) to power one or more components of user device 140, and a bus that allows communication among the various components of user device 140. Input/output interface 142 may include a display, which may include for example output devices, such as a printer, display screen (e.g., monitor, television, and the like), speakers, projector, and the like. Although not shown, each user device 140 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, and the like.

Input/output interface 142 may also include an NFC antenna and secure element (SE). The SE may be a hardware chip specially designed to be tamper proof. In one embodiment, the SE may be used for digitally and physically secure storage of sensitive data, including transaction card data, payment data, health records, car key identifiers, etc. The SE may, for example, store information related to a person, customer, financial institution, or other entity. The SE may store information related to a financial account, such as, for example, transaction card data (e.g., proximity data, a credit card number, debit account number, or other account identifier). The SE may include a computer processor or other computational hardware or software. As one example, the secure element may contain the Visa® and MasterCard® applications for PayWave® and PayPass® transactions. A secure element may take the form of a universal integrated circuit card (UICC) and/or a microSD card. A UICC may identify a user to a wireless operator, store contacts, enable secure connections, and add new applications and services, such as a location module.

Input/output interface 142 may enable Industry Standard NFC Payment Transmission. For example, the input/output interface 142 may enable two loop antennas to form an air-core transformer when placed near one another by using magnetic induction. Input/output interface 142 may operate at 13.56 MHz or any other acceptable frequency. Also, input/output interface 142 may provide for a passive communication mode, where the initiator device provides a carrier field, permitting answers by the target device via modulation of existing fields. Additionally, input/output interface 142 also may provide for an active communication mode by allowing alternate field generation by the initiator and target devices.

Input/output interface 142 may deactivate the RF field while awaiting data. The attachment may use Miller-type coding with varying modulations, including 100% modulation. The attachment may also use Manchester coding with varying modulations, including a modulation ratio of 10%. Additionally, the attachment may be capable of receiving and transmitting data at the same time, as well as checking for potential collisions when the transmitted signal and received signal frequencies differ.

Input/output interface 142 may be capable of utilizing standardized transmission protocols, for example but not by way of limitation, ISO/IEC 14443 A/B, ISO/IEC 18092, MiFare, FeliCa, tag/smartcard emulation, and the like. Also, input/output interface 142 may be able to utilize transmission protocols and methods that are developed in the future using other frequencies or modes of transmission. Input/output interface 142 may also be backwards-compatible with existing techniques, for example RFID. Also, the system may support transmission requirements to meet new and evolving standards including internet based transmission triggered by NFC.

Location services application 144 may cooperate with input/output interface 142 to generate and receive location data and proximity data associated with a transaction card 120. For example, location module may include various hardware and software components such as a processor and data storage to store transaction card data (e.g., distance data indicating a calculated distance between a user device and a transaction card or proximity data, time and date data associated with distance data, purchase data, and the like) and cardholder data (e.g., cardholder name, address, phone number(s), email address, demographic data, and the like). Location services application 144 may also generate and store location data associated with the user device 140. For example, location data may include GPS data, electro-magnetic field data, IP address data, and the like. In this manner, a user device 140 location services application 144 may be able to generate a report indicating the location of a user device over a specified period of time (e.g., a number of hours, a number of minutes, a number of days and the like) to illustrate possible locations for a transaction card based on where the user device 140 has been located. This location data may also be transmitted to an account provider system 130 for storage so that an account provider system may generate a similar report on-demand.

Location services application 144 may also request and receive proximity data using BLE from a transaction card 120 indicating a proximity of the transaction card 120 to the user device 140. Proximity data may include, for example, an existence of a connection, signal strength associated with the connection, response time data, and the like. For example, where a user device 140 and the transaction card 120 are greater than a specified distance apart from each other, the user device 140 may no longer receive connection data associate with the transaction card 120, may receive poor signal strength data associated with the transaction card 120, may receive a specific response time associated with a ping to the transaction card 120, and, in response may receive and/or generate a notification. The notification may be in the form of, for example, a push notification, a text message, a voice message, and the like. In this manner, the transaction card 120 acts as a beacon using a Bluetooth connection to tell the user device 140 a proximate location of the transaction card 120 to the user device 140.

In this manner, a location module may receive data from user device 140 indicating that a transaction card 120 outside of a specified distance is still approved for transaction usage. For example, where a parent or spouse provides a credit card to a child or spouse, respectively, for use, the user device associated with the account holder (e.g., parent or spouse) may receive an alert that the transaction card is outside a specified distance. The account holder may authorize the transaction card to be outside the specified distance for a period of time or until the account holder indicates otherwise on the user device 140. Such an authorization may be relayed to an account provider for storage with transaction data. In this fashion, a transaction card 120 may be “blocked” or “unblocked” based on input received at the user device 140.

Location services application 144 also may include hardware and software components to generate and/or receive notifications indicating that transaction card data (e.g., proximity data) associated with a transaction card 120 indicates that the transaction card is outside a specified distance from a user device 140. For example, a user device 140 may generate a notification based on the transaction card data (e.g., proximity data received via a BLE connection) and transmit the notification to the account provider system 130 and/or may receive a notification from a third party device associated with a Bluetooth mesh network.

Transaction services application 144 may include various hardware and software components, such as data storage and a processor that may work with input/output interface 142 to communicate between a merchant, acquisition system, account provider system, and/or a user device to process a transaction, such as a user purchase.

User device 140 may also include various software components to facilitate locating the proximity of a transaction card 120. For example, user device 140 may include an operating system such as, for example, the iOS operating system from Apple, the Google Android operating system, and the Windows Mobile operating system from Microsoft. User device 140 may also include, without limitation, software applications such as mobile banking applications and mapping applications to facilitate locating a transaction card 120, an NFC application programming interface, and software to enable touch sensitive displays. Mobile device manufacturers may provide software stacks or Application Programming Interfaces (APIs) which allow software applications to be written on top of the software stacks. For example, mobile device manufacturers may provide, without limitation, a card emulation API to enable NFC card emulation mode, a logic link control protocol (LLCP) API for peer-to-peer communication between mobile devices, a Bluetooth API supporting BLE, and a real-time data (RTD) API and a NFC Data Exchange Format (NDEF) API for reading/writing.

Software application on user device 140, such as mobile banking applications and applications associated with a transaction card 120, may include card on/off features that allow a cardholder associated with a user device 140 to enable and disable a transaction card. For example, when a user device 140 alerts a card holder that a transaction card 120 is outside a specified range, a card holder may use, for example, a mobile banking application stored on a user device 140 to disable the transaction card. If a transaction card is then located, a card holder may use, for example, a mobile banking application stored on a user device 140 to enable the transaction card 120. Also, the software application may respond to a notification based on data received at a user device 140 using BLE indicating a transaction card 120 is outside a specified distance from the user device 140 and disable the transaction card 120 automatically and enable the transaction card 120 when it is within a specified range of the user device 140. These features may be enabled or disabled using setting associated with a user device 140 and/or a software application.

Merchant system 150 may include, among other components, a PoS device (not shown), an input/output interface 152, and an authorization system 154. PoS device may include a variety of readers to read transaction data associated with a transaction taking place with a merchant. PoS device may include various hardware and/or software components required to conduct and process transaction. Merchant system 150 may also include data storage (not shown) to store transaction data and/or approval of charges between an cardholder and the merchant associated

An input/output interface 152 may include, for example, a transceiver, modems, network interfaces, buses, CD-ROM, keyboard, mouse, microphone, camera, touch screen, printers, USB flash drives, speakers, and/or any other device configured to receive and transmit electronic data. Input/output interface 152 may include for example, I/O devices, which may be configured to provide input and/or output to and/or from merchant system 150 (e.g., keyboard, mouse, display, speakers, printers, modems, network cards, etc.). Input/output interface 152 also may include antennas, network interfaces that may provide or enable wireless and/or wire line digital and/or analog interface to one or more networks, such as network 110, over one or more network connections, a power source that provides an appropriate alternating current (AC) or direct current (DC) to power one or more components of merchant system 150, and a bus that allows communication among the various components of merchant system 150. Input/output interface 152 may include a display, which may include for example output devices, such as a printer, display screen (e.g., monitor, television, and the like), speakers, projector, and the like. Although not shown, merchant system 150 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, and the like. Authorization system 154 may include various software and/or hardware component to enable authorization of a transaction at a merchant system using, for example, a PoS device.

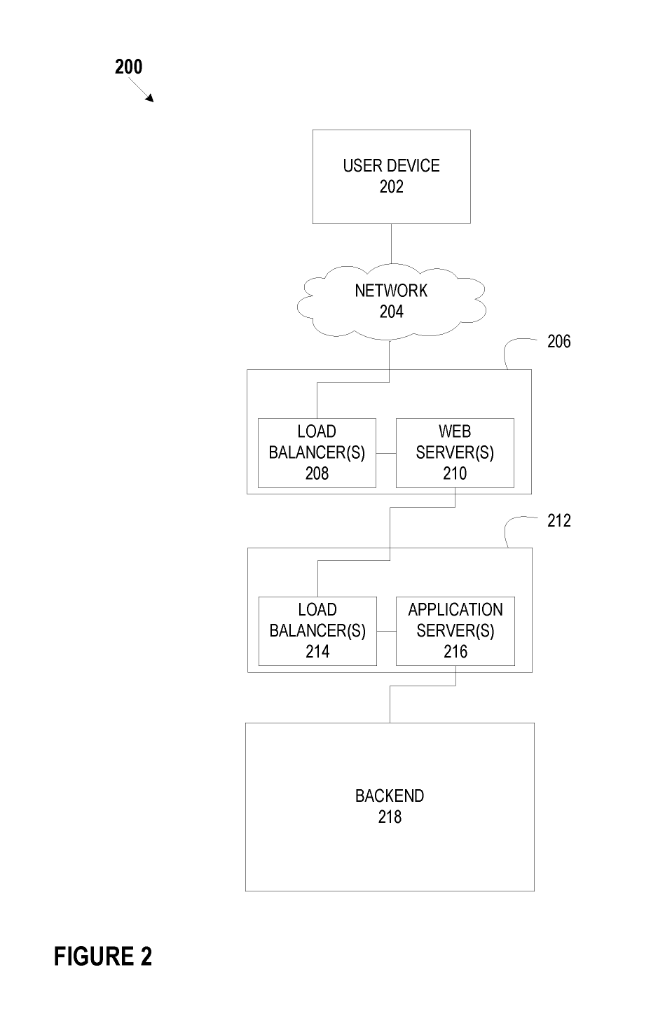

FIG. 2 depicts an example system used in locating a transaction card. The example system 200 in FIG. 2 may enable a financial institution, for example, to provide network services to its cardholders, and may include providing lost or misplaced transaction card data to a user device. As shown in FIG. 2, system 200 may include a user device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

User device 202 may be a network-enabled computer. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

User device 202 also may be a mobile device. For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device. Cardholder device 202 also may be similar to cardholder device 120 as shown and described in FIG. 1.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(S) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, cardholder device 202, connect to access various services of a financial institution, for example. Load balancer(s) 208 may forward requests to one of the application servers 216 and/or backend 218 servers, which may then reply to load balancer 208. This may allow load balancer(s) 208 to reply to cardholder device 202 without cardholder device 202 ever knowing about the internal separation of functions. It also may prevent cardholder devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP/HTTPS compression; TCP offloading; TCP buffering; direct server return; health checking; HTTP/HTTPS caching; content filtering; HTTP/HTTPS security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., cardholder device 202) through a network (e.g., network 204), such as the Internet. In various examples, web servers, may deliver web pages, relating to, for example, online banking applications and the like, to clients (e.g., cardholder device 202). Web server(s) 210 may use, for example, a hypertext transfer protocol (HTTP/HTTPS or sHTTP) to communicate with cardholder device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP/HTTPS and web server 210 may respond with the content of that resource or an error message if unable to do so. The resource may be, for example a file on stored on backend 218. Web server(s) 210 also may enable or facilitate receiving content from cardholder device 202 so cardholder device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the NET framework from Microsoft®, PHP application servers, and the like). The various application server frameworks may contain a comprehensive service layer model. Also, application server(s) 216 may act as a set of components accessible to, for example, a financial institution, or other entity implementing system 200, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributed system similar to system 200. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and/or a location system, which may include additional capabilities, such as transaction card data generation and provision to enable the location, proximity, or a transaction card and/or transmission of lost or misplaced transaction card data. Backend 218 may be associated with various databases, including account databases that maintain, for example, cardholder information (e.g., demographic data, credit data, cardholder profile data, and the like), transaction card databases that maintain transaction card data (e.g., transaction history, user device location associated with transaction, location data, proximity data representing a distance between transaction card and user device, approved “lost mode” override time and date information, and the like), and the like. Backend 218 also may be associated with one or more servers that enable the various services provided by system 200. Backend 218 may enable a financial institution to implement various functions associated with reprogramming a transaction card as shown and described herein.

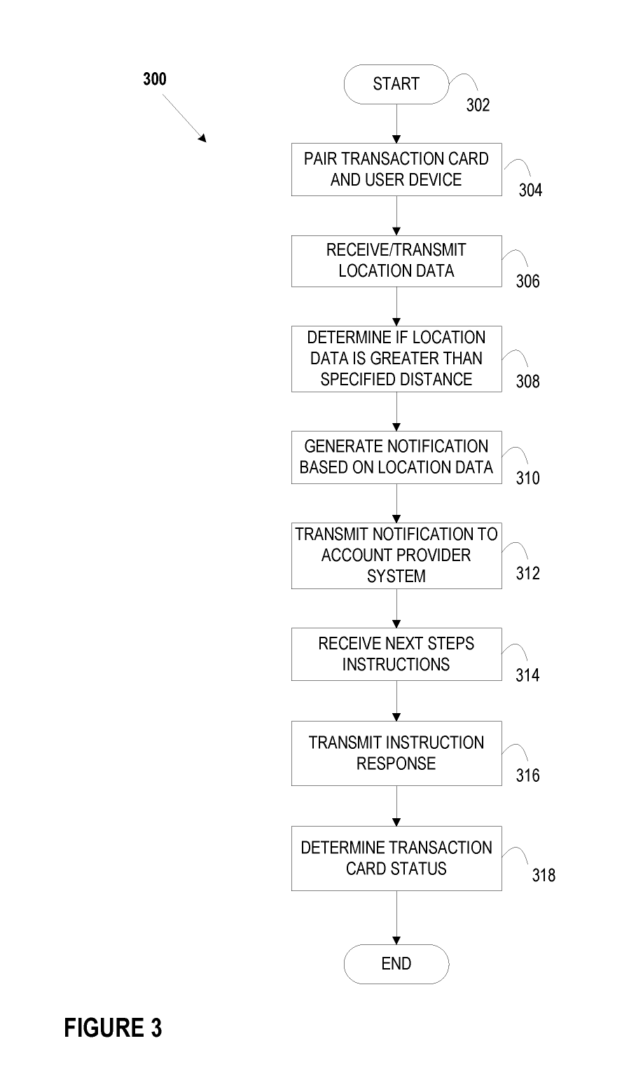

FIG. 3 depicts an example method 300 employed by the system components described herein to use a bluetooth connection to locate a bluetooth-enabled transaction card, similar to, for example, transaction card 120 and/or 410. Method 300 may begin at 302.

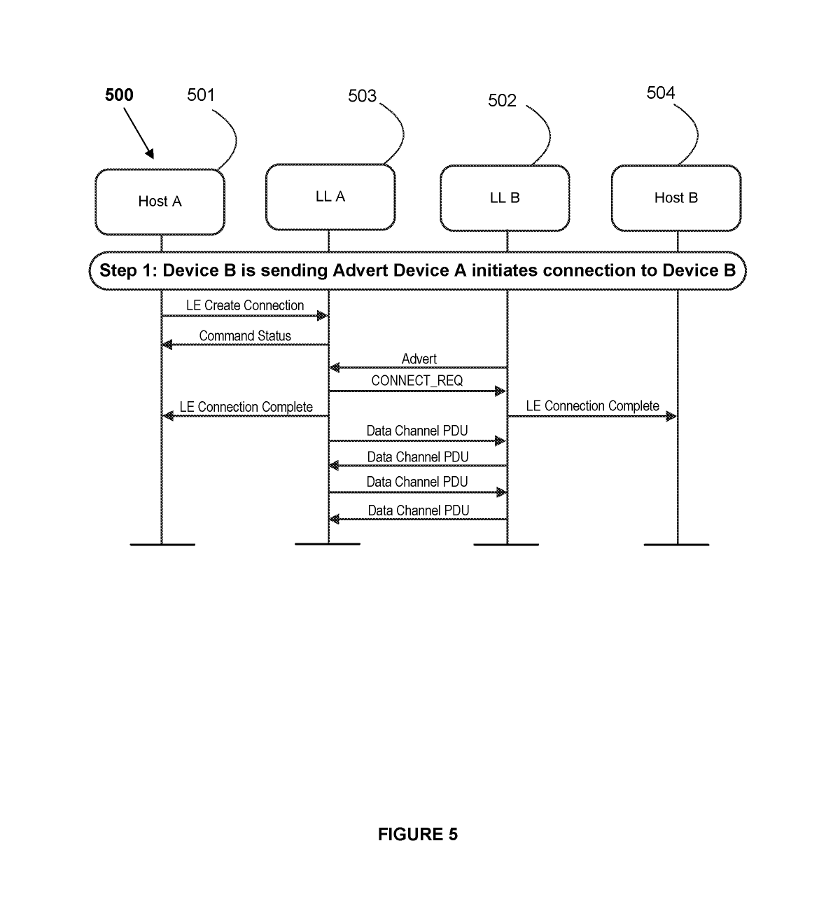

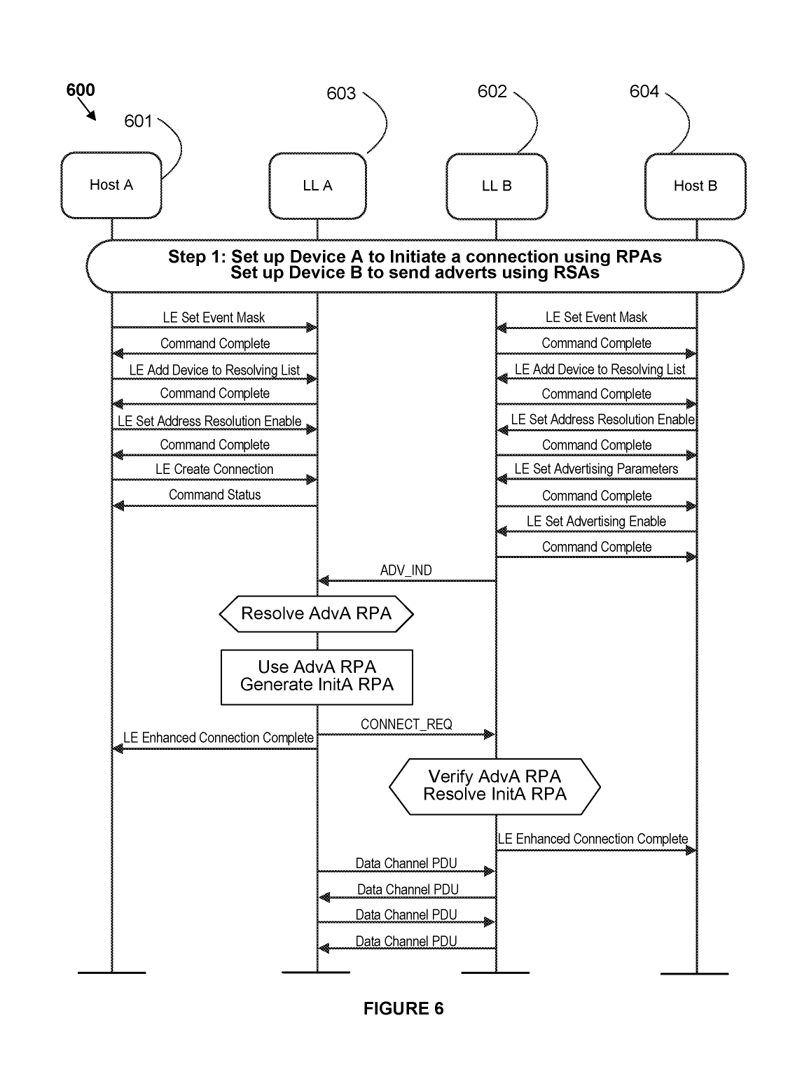

In block 304, a transaction card, similar to transaction card 120 and/or 410, may be paired using Bluetooth technology to a user device, similar to user device 140. A Bluetooth-enabled device may include the capabilities to establish a link between a card and the device (or pair the devices) using device settings (e.g., iOS or Android settings that manage Bluetooth connections, such as BLE connections) and/or mobile application(s) associated with the card issuer that can cooperate with the device controls to manage a Bluetooth connection with the card. For example, the device and card may enter a connection state from the initiating state or advertising state. In so doing, the master and slave roles of the device and card will be defined. Before entering the connection state, the card and/or device may be in an advertising or initiating state. In this example, a link layer (LL) of the device may support multiple state machines to support various combinations of states and roles. Also, the connection state may be entered when the respective transceiver of the card and device are tuned to the same RF channel at the same time. FIG. 5 depicts an example system and method 500 for initiating a connection between a device 501 and card 502 and the respective link layers 503, 504. FIG. 6 also depicts an example system and method 600 for initiating a connection between a device 601 and card 602 and the respective link layers 603, 604 with privacy.

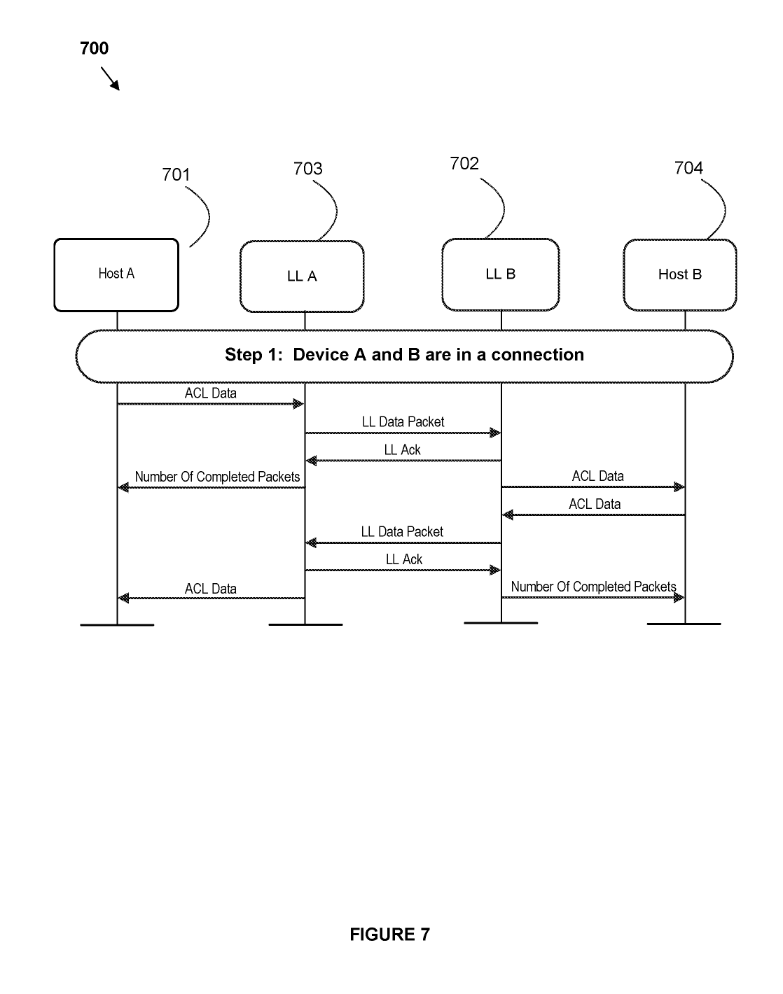

Once paired, each paired device (e.g., transaction card and user device) may transmit and/or receive data, such as location data (block 306). FIG. 7 depicts an example system and method 700 for sending data between device 701 and card 700 using the respective link layers 703, 704. Proximity data may include, for example, data representing a proximity of the transaction card to the user device. For example, proximity data may include an existence of a connection, signal strength associated with the connection, response time data, and the like. A proximity of a transaction card in relation to a user device may be calculated based on the proximity data. For example, where a user device 140 and the transaction card 120 are greater than a specified distance apart from each other, the user device 140 may no longer receive connection data associate with the transaction card 120, may receive poor signal strength data associated with the transaction card 120, may receive a specific response time associated with a ping to the transaction card 120, and, in response may receive and/or generate a notification. In various embodiments, connection parameters associated with the Bluetooth connection also may be used to determine proximity and connection status. The notification may be in the form of, for example, a push notification, a text message, a voice message, and the like. In this manner, the transaction card 120 acts as a beacon using a Bluetooth connection to tell the user device 140 a proximate location of the transaction card 120 to the user device 140.

The transmission and receipt of data may be over a short range wireless link (e.g., 30 to 300 foot radius). In order to transmit and/or receive data, each Bluetooth-enabled device may include a location module including a Bluetooth chipset and a Bluetooth transceiver, where the chip includes a microprocessor to provide functionality associated with device control and the piconet, or the network created using wireless Bluetooth connection.

A user device may continuously receive proximity data from a Bluetooth-enabled transaction card or may receive proximity data at predefined intervals (e.g., any number of second, minutes, or hours). The predefined intervals may be controlled via a user device and/or an account provider system. Upon the receipt of proximity data from a transaction card, a user device may calculate if the proximity data indicates that the transaction card is greater than a specified distance from the user device (block 308). Connection parameters also may be used to determine whether the card and device maintain a connection. The specified distance may be a maximum Bluetooth network distance or a distance less than the maximum Bluetooth network distance. For example, where the Bluetooth network distance is 300 feet, a specified distance may be 200 feet.

At block 310, a notification may be generated on the user device based on the proximity data received from the transaction card. For example, a notification may indicate an approximate distance from the transaction card, or simply that the user device is outside the specified distance from the transaction card. Where a transaction card is within the range of a specified distance notification may not be generated.

At block 312, the notification may be transmitted to an account provider system along with proximity data and/or location data. For example, where a notification indicates an approximate distance from the transaction card, or simply that the user device is outside the specified distance from the transaction card, the notification along with proximity data and/or location data associated with the user device may be transmitted. In this manner, the account provider system may store data associated with where a user device was located at the time the transaction card was lost or misplaced. Notifications and alerts may be provided in the form of a push notification, a text, a voice message, and/or application notification such as those associated with mobile banking applications. In various embodiments, locating a transaction card could be provided with the assistance of a network environment, such as a Bluetooth network and/or a Bluetooth mesh network environment. Notifications may include a selection for next steps, such as disabling/enabling a transaction card, asking a user if the user would not like to be notified about the transaction card proximity data for a user-defined period of time (any number of minutes, hours, days, etc.), asking a user if the user would not like to be notified about the transaction card proximity data until the transaction card is used to process a transaction, and the like.

At block 314, a user device may receive next step instructions in response to the notification based on proximity data. For example, next step instruction may include an indication that a transaction card outside of a specified distance is still approved for transaction usage, an indication that a transaction card is to be disabled for further use, a response to stop sending notifications for a specified amount of time (e.g., a number of minutes or hours), a request for a report indicating various proximity, location, and transaction data associated with the user device and transaction card, and the like.

For example, an indication that a transaction card outside a specified distance is still approved for transaction usage may occur where a parent or spouse provides a credit card to a child or spouse, respectively, for use, the user device associated with the account holder (e.g., parent or spouse) may receive an alert that the transaction card is outside a specified distance. The account holder may authorize the card to be outside the specified distance for a period of time or until the account holder indicates otherwise on the user device. In this fashion, a transaction card may be “blocked” or “unblocked” based on input received at the user device.

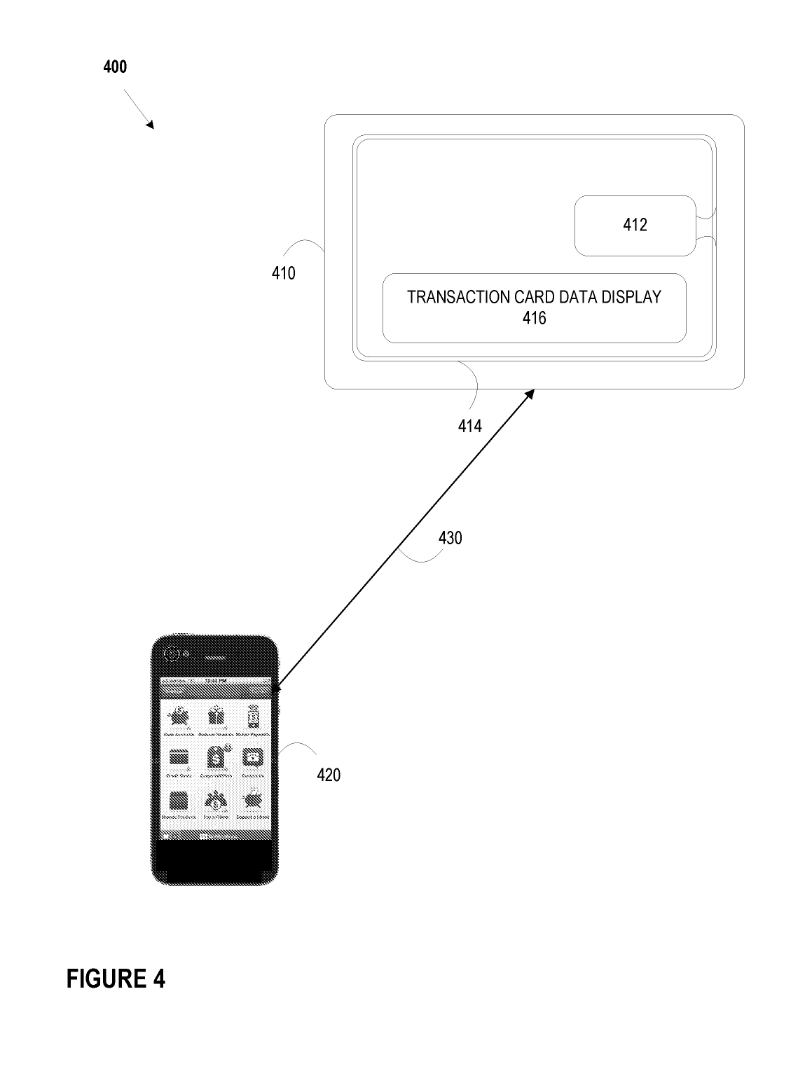

As another example, an indication that a transaction card is to be disabled for further use may be received when a user has lost or misplaced a transaction card and wishes to disable the card until it is found or replaced. An indication that a transaction card is to be disabled may be automatically generated by a user device or account provider system and received at the account provider system when the transaction card is outside a specified range away from a user device. An indication that a card is to be disabled may put a transaction card in “lost mode.” While in “lost mode,” a transaction card with a dynamic display may display a message from an account holder, such as contact information associated with the account holder. Looking at FIG. 4, a system 400 with a Bluetooth-enabled card 410 may include a transaction card data display 416. Accordingly, either based on data received from a user device 420 and/or based on a missing Bluetooth connection 430 from a user device, the transaction card data display 416 may display predefined data and/or data received from a user device. The transaction card data may include data received via an antenna 414 and stored in a microprocessor 412.

A response to stop sending notifications for a specified amount of time (e.g., a number of minutes or hours) may be received when a card holder is at an establishment (e.g., restaurant, bar, or the like) and the account holder provides the establishment with the transaction card for processing and/or safe holding (e.g., an account holder desires to hold a tab open at a bar and the bar maintains control of the transaction card). In this manner, a user device may limit the number of notifications received by limiting the time between proximity data requests from the transaction card. A request for a report indicating various proximity, location, and transaction data associated with the user device and transaction card may be received, for example, when a user has lost or misplaced a transaction card and desires to obtain information associated with recent transactions and/or proximity data and/or location data associated with the transaction card and/or user device.

At block 316, a user device may transmit the instruction response to an account provider system, third party system, and/or display associated with the user device. In this manner, an account provider or third party system may generate requested data and/or store the transmitted data for future requests and/or reports. Additionally, a user device may display any requested data available on the user device.

At block 318, a user device and/or account provider system may determine a transaction card status based on the next step instructions (e.g., card blocked, card unblocked, card active, card cancelled, and the like). Accordingly, up-to-date transaction card status data may be maintained.

At block 320, the method may end. These examples are merely illustrative and transaction cards may be reprogrammed according to any data described herein.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.”

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A user device comprising:
an input/output interface comprising an antenna component that is paired to a Bluetooth-enabled transaction card and receives proximity data from the transaction card via Bluetooth network;
a processor that generates a notification to alert a user that the proximity data received from the transaction card indicates that the transaction card is greater than a specified distance from the user device, wherein input/output interface receives a response from the user based on the notification, wherein the processor performs at least one of the following based on the response:
generates deactivation data associated with the transaction card and transmits the deactivation data using the input/output interface to an account provider system;
generates an override alert associated with the transaction card and transmits the override alert using the input/output interface to an account provider system;
generates a report including the proximity data received from the transaction card and GPS data received via a GPS component on the user device; and
generates user-specified transaction card display data and transmits the transaction card display data using the input/output interface to the transaction card to display on a dynamic display;
wherein the account provider system manages the account and participates in transaction authorization associated with the transaction card.

2. The user device of claim 1, wherein the proximity data received from the transaction card via Bluetooth network is Bluetooth low energy data.

3. The user device of claim 1, wherein the proximity data includes at least one of: existence of a connection, signal strength associated with the connection, response time data.

4. The user device of claim 1, wherein the specified distance is user-specified, and wherein the user-specified distance is received on the user device via an input/output interface comprising at least one of: a touchscreen and a keyboard.

5. The user device of claim 1, wherein the specified distance is account provider-specified, and wherein the account provider-specified distance is received from the account provider system via an input/output interface on the user device.

6. The user device of claim 1, wherein processor the notification is received via a network and comprises at least one of: a push notification, a text message, a voice message, and a vibration notification.

7. The user device of claim 1, further comprising a receiver to receive location data including at least one of: a global positioning system (GPS) data, radio signal data, electro-magnetic data, and IP address data.

8. The user device of claim 1, wherein the deactivation data includes at least one of the following: transaction card number, deactivation time, deactivation date, account holder name, and location data associated with the user device.

9. The user device of claim 1, wherein the override alert includes at least one of the following data: transaction card number, time, date, account holder name, and location data associated with the user device.

10. The user device of claim 1, further comprising a display to display the generated report in a map format mapping GPS data associated with the user device.

11. The user device of claim 1, wherein the transaction card display data includes at least one of: an account holder name, an account holder contact phone number, and a deactivation message.

12. A Bluetooth-enabled transaction card comprising:
a microprocessor chip storing transaction card data; and
an antenna connected to the microprocessor chip, wherein the antenna:
receives a pairing attempt from a user device over a Bluetooth network;
establishes a Bluetooth connection with the user device;
receives a request for proximity data from the user device;
transmits the proximity data to the user device in response to the request; and
receives an deactivation response from the user device indicating that the transaction card is deactivated.

13. The transaction card of claim 12, wherein the Bluetooth-enabled transaction card uses Bluetooth low energy.

14. The transaction card of claim 12, wherein the proximity data includes at least one of: existence of a connection, signal strength associated with the connection, and response time data.

15. The transaction card of claim 12, wherein the transaction card data includes at least one of: an account holder name, an account holder identifier, an account number, an account balance, a transaction history, and an account holder contact telephone number.

16. The transaction card of claim 12, wherein the request for proximity data is from the user device at predefined intervals.

17. The transaction card of claim 12, wherein the transmitted proximity data is transmitted at predefined intervals.

18. The transaction card of claim 12, wherein the transmitted proximity data is transmitted only upon receipt of the request for proximity data from the user device.

19. The transaction card of claim 12, wherein the deactivation data includes at least one of the following: account holder name, an account holder contact phone number, and a deactivation message.

20. The transaction card of claim 19, further comprising a display to display the deactivation data.
